(19) United States
(12) Patent Application Publication
(10) Pub. No.: US 2015/0321930 A1
(43) Pub. Date: Nov. 12, 2015

(54) SYSTEMS AND METHODS FOR TREATING HEAVY METAL WASTEWATER

(71) Applicant: IAOTONG UNIVERSITY, Shanxi ,Xian (CN)

(72) Inventors: Yun-hai WANG, Xi'an, Shanxi (CN); Qing-yun CHAN, Xi'an, Shanxi (CN); Rong FU, Xi'an, Shanxi (CN); Ya-peng LIU, Xi'an, Shanxi (CN)

(73) Assignee: Xi'an Jiaotong University, Shanxi, Xi'an (CN)

(21) Appl. No.: 14/410,529

(22) PCT Filed: Jul. 18, 2012
(86) PCT No.: PCT/CN2012/078809

§ 371 Date: Dec. 22, 2014

(51) Int. Cl. C02F 1/467; C02F 1/461

(52) U.S. Cl. CPC C02F 1/4678; C02F 1/46109; C02F 2101/20

(57) ABSTRACT

Methods for treating wastewater containing one or more heavy metals are disclosed. The methods can include providing a fuel cell, the fuel cell including: an anode having a catalyst; a cathode electrically coupled to the anode; and an ion-exchange membrane disposed between the anode and the cathode. The methods may also include contacting a fuel to the anode to oxidize the fuel and contacting the wastewater to the cathode to reduce at least a portion of the heavy metals in the wastewater. The methods for treating wastewater may advantageously provide an efficient means for treating the wastewater while producing electricity. Systems for treating wastewater are also disclosed.

### BACKGROUND

Pollution of aqueous solutions and air is an expanding issue in the modern world. An ever-growing number of toxic pollutants are produced by industries, such as, for example, textile industries, chemical industries, pharmaceutical industries, pulp and paper industries, and food processing plants. The majority of these toxic pollutants are released within two primary fluid physical states: water and air. As the scope of water and air-borne pollutant production increases worldwide, the concerns over the risks imposed by these released pollutants on the environment also increases. Additionally, environmental regulations are requiring that these released fluid streams contain less and less pollutants. In fact, some treatment processes that were acceptable options at one point in time are now obsolete because more stringent treatment standards are required as new environmental regulations are implemented on the state and federal level

A variety of wastewater purification methods have been developed. Some techniques for removing the contaminants involve use of strong oxidants, which may themselves be hazardous. Other techniques remove the contaminant from the fluid but then release the contaminant into the air or produce a contaminant output, which must be disposed of.

### SUMMARY

Some embodiments disclosed herein include a method for treating wastewater containing one or more heavy metals. The method may include: providing a fuel cell having an anode containing a catalyst, a cathode electrically coupled to the anode, and an ion-exchange membrane disposed between the anode and the cathode; contacting a fuel to the anode to oxidize the fuel; contacting the wastewater to the cathode to reduce at least a portion of the heavy metals in the wastewater. In some embodiments, an electrical current flows between the anode and the cathode.

Some embodiments disclosed herein include a system for treating wastewater. The system including: an anode having a catalyst; a cathode electrically coupled to the anode; an ion-exchange membrane disposed between the anode and the cathode; a first input port configured to provide a fuel to the anode; a second input port configured to provide a wastewater to the cathode; and a heavy metal sensor configured to measure an amount of one or more heavy metal ions in the wastewater.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 is one example of a fuel cell that may be used in a method for treating wastewater that is within the scope of the present application.

FIG. 2 is one example of a system for treating wastewater that is within the scope of the present application.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Some embodiments disclosed herein include a method for treating wastewater containing one or more heavy metals. The method can include providing a fuel cell, the fuel cell including: an anode having a catalyst; a cathode electrically coupled to the anode; and an ion-exchange membrane disposed between the anode and the cathode. The method may also include contacting a fuel to the anode to oxidize the fuel and contacting the wastewater to the cathode to reduce at least a portion of the heavy metals in the wastewater. In some embodiments, an electrical current flows between the anode and the cathode. The method for treating wastewater may, in some embodiments, advantageously provide an efficient means for treating the wastewater while producing electricity. Also disclosed are systems for treating wastewater.

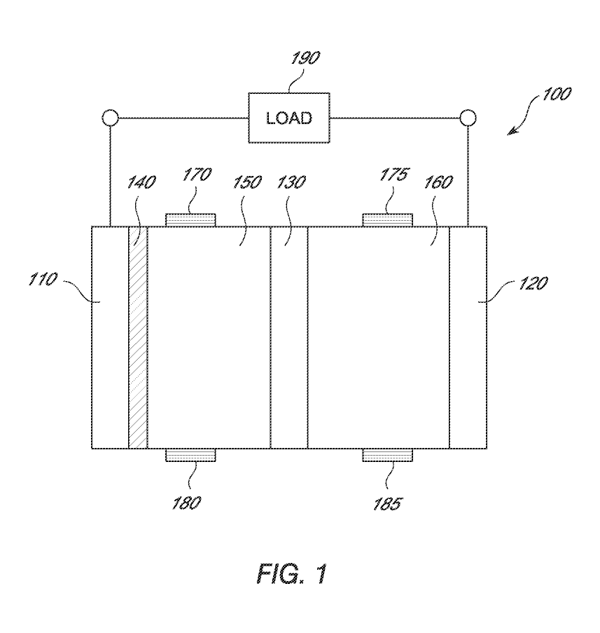

FIG. 1 is one example of a fuel cell that may be used in a method for treating wastewater that is within the scope of the present application. Fuel cell 100 includes anode 110, cathode 120, and ion-exchange membrane 130. Anode 110 can include at least one catalyst 140 configured to catalyze oxidation of a fuel. First chamber 150 can be disposed between ion-exchange membrane 130 and anode 110, and configured to receive at least one fuel that can contact anode 110. Similarly, second chamber 160 can be disposed between ion-exchange membrane 130 and cathode 120, and configured to receive wastewater that can contact cathode 120. Anode 110 and cathode 120 may be electrically coupled together via load 190. Fuel cell 100 can also include first input port 170 and second input port 175 configured to supply a fuel to first chamber 150 and wastewater to second chamber 160, respectively. Fuel cell 100 may also optionally include first output port 180 and second output port 185 configured to receive an oxidized fuel that has contacted anode 110 and treated wastewater that has contacted cathode 120, respectively.

Numerous fuel cell configurations are known in the art, and the present application is not limited to fuel cell 100 depicted in FIG. 1. For example, the relative location of the anode, the ion-exchange membrane, and the first chamber configured to receive the oxidized fuel can vary so long as the fuel can contact the anode and an appropriate ion can be exchanged between the ion-exchange membrane and the fuel. Thus, in some embodiments, the anode may be disposed between the ion-exchange membrane and the first chamber configured to receiving the fuel. Similarly, the cathode, the ion-exchange membrane, and the second chamber for receiving the wastewater can vary so long as the wastewater can contact the cathode and an appropriate ion can be exchanged between the ion-exchange membrane and the fuel. In some embodiments, the anode, the cathode, and the ion-exchange membrane are hot-pressed together in the fuel cell.

The anode (e.g. anode 110 depicted in FIG. 1) is not particularly limited, and various anodes are known in the art. The anode may be composed of an inert material that generally does not react with fuel that is oxidized. The anode can be composed of, for example, one or more of carbon cloth, glassy carbon, graphite, nickel foam, and the like. The cathode (e.g. cathode 120 depicted in FIG. 1) can similarly be composed of inert materials such as those described above with regard to the anode.

The anode may include at least one catalyst (e.g. catalyst 140 depicted in FIG. 1) to catalyze oxidation of the fuel. In some embodiments, the catalyst is a metal or a metal oxide. Non-limiting examples of catalysts include Pt, Ru, Rh, Os, combinations thereof, or alloys thereof (e.g., Pt—Ru or Pt—Sn). The catalyst may vary depending on the fuel that is supplied to the anode. For example, Pt/C catalyst may be selected for oxidizing hydrogen, while Pt—Ru/C catalyst may be selected for oxidizing methanol. As another example, Pt—Ru/C catalyst may be selected for oxidizing ethanol. The amount of catalyst on the anode may be an amount effective to catalyze the fuel when contacting the anode. The amount of catalyst on the anode may be, for example, at least about 0.01 mg/cm²; at least about 0.1 mg/cm²; at least about 0.5 mg/cm²; at least about 0.8 mg/cm²; or at least about 1.5 mg/cm².

The methods for treating wastewater use catalysts rather than microorganisms (e.g. as typically found in a microbial fuel cell). In some embodiments, a majority of the fuel is catalytically oxidized using a metal or metal oxide catalyst. In some embodiments, the fuel cell is substantially free of microorganisms configured to oxidize the fuel.

The ion-exchange membrane is not particularly limited, and numerous ion-exchange membranes are known in the art. The ion-exchange membrane can be, for example, a cation-conducting membrane, an anion-conducting membrane, or a bipolar membrane. The bipolar membrane typically is a composite including a cation-conducting membrane and a anion-conducting membrane. When using the bipolar membrane, the cation-exchange membrane typically faces the cathode, while the anion-exchange membrane faces the anode. These membranes can be commercially available. For example, NAFION is one example of a cation-exchange membrane commercially available from DuPont. As another example, FUMASEP FBM is one example of a bipolar membrane available from Fumatech. The ion-exchange membrane can be selected, in part, based on the fuel supplied to the anode. For example, a cation-exchange membrane may be selected for exchanging protons from oxidized hydrogen to the chamber containing the wastewater (e.g. second chamber 160 depicted in FIG. 1).

The anode and the cathode can be electrically coupled together. Thus, in some embodiments, an electrical current may flow between the anode and the cathode during operation of the fuel cell. A load (e.g. load 190 depicted in FIG. 1) may be electrically coupled between the anode and the cathode. The load can be, for example, a battery configured to be charged by the voltage between the anode and the cathode. As another example, the load may be a motor powered by the electrical current between the anode and the cathode. A power output from the fuel cell relative to an area of the anode may be, for example, at least about 10 W/m²; at least about 25 W/m²; the least about 50 W/m²; the least 75 W/m²; at least about 100 W/m²; or least about 120 W/m².

The method can include supplying at least one fuel to contact the anode. For example, referring to FIG. 1, the fuel may be supplied via first input port 170 into first chamber 150 so that the fuel can contact anode 110. The fuel may be any material that can be oxidized when contacting the anode. Numerous fuels are known in the art for use in fuel cells, and any of these fuels are within the scope of the present application. A mixture of two or more different fuels may optionally be used. In some embodiments, the fuel can be a saturated or unsaturated, branched or unbranched hydrocarbon, such as methane, ethane, propylene, or isopentane. In some embodiments, the fuel can be an alcohol, such as methanol, ethanol, isopropanol, or glycerol. The alcohol may, for example, be an alkanol having about 1 to about 20 carbon atoms, or about 1 to about eight carbons. In some embodiments, the fuel is hydrogen. As noted above, the catalysts on the anode may vary depending upon the fuel supplied to the anode.

The method also includes contacting the wastewater having one or more heavy metals with the cathode. For example, referring to FIG. 1, wastewater can be supplied via first input port 175 into second chamber 160 so that the wastewater can contact the cathode. The wastewater may contain one or more oxidized heavy metals. These heavy metals may, in some embodiments, be environmentally undesirable or toxic. Thus, in some embodiments, the methods disclosed herein may reduce the heavy metals into an environmentally friendlier or less toxic oxidation state. In some embodiments, the methods disclosed herein may reduce the heavy metals so that they separate from the wastewater (e.g., precipitate from the wastewater or deposit on the cathode). Non-limiting examples of heavy metals that may be included in the wastewater as an oxidized form are Cr, Cu, Cd, Hg, Au, and Ag. Examples of oxidized forms include, but are not limited to, Cu²⁺, Au^{3′}, Au⁺, Cr⁶⁺, Ag⁺, and Hg²⁺. A plurality of heavy metals (e.g. two, three, or, or more heavy metals) may be present in the wastewater. The oxidized heavy metals in the wastewater may, for example, be in the form of a complex, a metal oxide, or a salt. Non-limiting examples of complexes that may be present in the wastewater include Au(CN)₂⁻, Ag(CN)₂⁻, Ag(NH₃)₂⁺, AgCN, Cu(NH₃)₄²⁺, Cu(NH₃)₂⁺, Cu(EDTA)²⁻, and HgCl₄²⁺. Copper sulfate is one example of a salt form of a heavy metal that may be present in the wastewater.

The total amount of heavy metals in the wastewater before contacting the cathode can vary. The total amount of heavy metals in the wastewater before contacting the cathode can be, for example, at least about 1 ppb; at least about 100 ppb; at least about 1 ppm; at least about 5 ppm; at least about 10 ppm; at least about 0.01% by weight; or at least about 0.1% by weight. The total amount of heavy metals in the wastewater before contacting the cathode can be, for example, no more than about 5% by weight; no more than about 1% by weight; no more than about 0.1% by weight; or no more than about 500 ppm. In some embodiments, the total amount of heavy metals in the wastewater before contacting the cathode can be from about 1 ppb to about 5% by weight, or from about 1 ppm to about 0.1% by weight.

The amount of at least one heavy metal (e.g., one, two, three, or more of Cu²⁺, Au³⁺, Au⁺, Cr⁶⁺, Ag⁺, or Hg²⁺) in the wastewater before contacting the cathode can vary. The amount of any single heavy metal in the wastewater can be, for example, at least about 1 ppb; at least about 100 ppb; at least about 1 ppm; at least about 5 ppm; at least about 10 ppm; at least about 0.01% by weight; or at least about 0.1% by weight. The amount of any single heavy metal in the wastewater before contacting the cathode can be, for example, no more than about 5% by weight; no more than about 1% by weight; no more than about 0.1% by weight; or no more than about 500 ppm. In some embodiments, the amount of any single heavy metal in the wastewater before contacting the cathode can be from about 1 ppb to about 5% by weight, or from about 1 ppm to about 0.1% by weight.

The method may include, in some embodiments, contacting the fuel with the anode at about the same time as the wastewater contacts the cathode. Without being bound to any particular theory, it is believed that oxidizing the fuel produces an electrical current between the anode and the cathode, while the wastewater or fuel receives an ion from the ion-exchange membrane. This process can result in reducing the heavy metals in the wastewater. For example, Cr⁶⁺ may be reduced to Cr³⁺, which is believed to exhibit lower toxicity. The chemical reaction when treating wastewater with Cr⁶⁺ and using methanol as the fuel may be:

Cathode: Cr₂O₄²⁻+8H⁺+6e⁻→2Cr³⁺+4H₂O

Anode: CH₃OH+OH⁻→CO₂+5H⁺+6e⁻

The wastewater can be any source of water having an undesirable amount of oxidized heavy metals. The wastewater can include, but is not limited to, electroplating waste, mining waste, silver plating waste, industrial chemical waste, metallurgy waste, textile manufacturing waste, leather processing waste, or pesticide manufacturing waste.

The fuel and wastewater may be processed in a batch process, a continuous process, or a combination of both a batch and a continuous process. For example, referring to FIG. 1, a fixed volume of fuel may be disposed in first chamber 150, and a fixed volume of wastewater may be disposed in second chamber 160. The oxidation of the fuel and reduction of the wastewater can continue until the reaction is complete or when an amount of one or more heavy metals reaches acceptable levels. As another example, the fuel may continuously flow into first chamber 150 via first input port 170 and exit via first output port 180. The wastewater may also continuously flow into second chamber 160 via second input port 175 and exit via second output port 185. As another example, a fixed volume of wastewater may be disposed in second chamber 160, while a fuel continuously flows through first chamber 150. The rate or volume of the fuel or wastewater being delivered into the fuel cell may vary according to numerous factors, such as size of the fuel cell, the type of fuel, and the contents of the wastewater (e.g., the amount of heavy metals in the wastewater).

The process may result in at least a portion of at least one heavy metal in the wastewater being reduced (e.g., one, two, three, or more of Cu²⁺, Au³⁺, Au⁺, Cr⁶⁺, Ag⁺, or Hg²⁺ in the wastewater can be reduced). The amount of the at least one heavy metal in the wastewater that is reduced may be, for example, at least about 50% by weight; at least about 70% by weight; at least about 90% by weight; or at least about 95% by weight. In some embodiments, the amount of Cu²⁺ in the wastewater after contacting the cathode is no more than about 10 ppm, no more than about 1 ppm, or no more than about 1 ppb. In some embodiments, the amount of Au⁺ in the wastewater after contacting the cathode is no more than about 10 ppm, no more than about 1 ppm, or no more than about 1 ppb. In some embodiments, the amount of Au³⁺ in the wastewater after contacting the cathode is no more than about 10 ppm, no more than about 1 ppm, or no more than about 1 ppb. In some embodiments, the amount of Cr⁶⁺ in the wastewater after contacting the cathode is no more than about 10 ppm, no more than about 1 ppm, or no more than about 1 ppb. In some embodiments, the amount of Hg²⁺ in the wastewater after contacting the cathode is no more than about 10 ppm, no more than about 1 ppm, or no more than about 1 ppb.

The method may also optionally include measuring an amount of at least one of the heavy metals in the wastewater. The measurement may occur before the wastewater contacts the cathode, after the wastewater contacts the cathode, or at about the same time as the wastewater contacts the cathode. In some embodiments, the wastewater is maintained in contact with the cathode or within a chamber containing the cathode (e.g. second chamber 160 depicted in FIG. 1) until an amount of at least one oxidized form of a heavy metal is below a predetermined amount. In some embodiments, the wastewater is recirculated into the chamber containing the cathode one or more times until an amount of at least one oxidized form of a heavy metal is below a predetermined amount.

The temperature of the fuel cell while treating the wastewater can have varying temperatures. The fuel cell may have a temperature of, for example, at least about −5° C.; at least about 10° C.; at least about 20° C.; at least about 30° C.; or least about 40° C. The fuel cell may have a temperature of, for example, no more than about 50° C.; no more than about 40° C.; no more than about 30° C.; no more than about 20° C.; or no more than about 10° C. The methods of the present application may, in some embodiments, advantageously operate at a wide range of temperatures relative to those used with microbial fuel cells. Thus, for example, the temperature of the fuel cell may be less than about 20° C. or more than about 30° C.

The method may optionally include harvesting at least a portion of the reduced metals produced by contacting the cathode. For example, Au⁺ may be reduced to elemental Au that deposits on the cathode. The Au can be removed from the cathode using, for example, leaching. As another example, Hg²⁺ may be reduced to elemental form and precipitate from the wastewater (e.g. precipitate as a powder). The precipitate may be collected by filtration, centrifugation, and the like. Although heavy metals may be harvested from the wastewater, in some embodiments, at least a portion of the reduced heavy metals remain in the wastewater after processing. In some embodiments, the method does not include harvesting a heavy metal that is reduced at the cathode.

At least one electrolyte may, in some embodiments, be combined with the fuel or the wastewater to improve ionic conductivity during processing. In some embodiments, both the fuel and the wastewater are combined with an electrolyte. Non-limiting examples of electrolytes that may be included with the fuel or the wastewater include H₂SO₄, H₃PO₄, KOH, Na₂SO₄, K₂SO₄, Na₂CO₃, K₂CO₃, and the like.

Some embodiments disclosed herein include a method of treating a sample suspected of containing one or more heavy metals. The method can include providing a fuel cell. The fuel cell may have any of the characteristics disclosed in the present application (e.g. the fuel cell can be fuel cell 100 as depicted in FIG. 1). The method also includes contacting a fuel to the anode to oxidize the fuel, and contacting the sample to the cathode to reduce at least a portion of any heavy metals in the sample. The fuel can be any of those disclosed above. For example, the fuel can be an alkanol, such as methanol or ethanol.

The sample suspected of containing one or more heavy metal may be wastewater. In some embodiments, the wastewater can be at least one of electroplating waste, mining waste, silver plating waste, industrial chemical waste, metallurgical waste, textile manufacturing waste, whether processing waste, or pesticide manufacturing waste. In some embodiments, an amount of at least one oxidized heavy metal can be measured in the sample after contacting the cathode. For example, an amount of at least one of Cu²⁺, Au⁺, Au⁺, Cr⁶⁺, Ag or Hg²⁺ (e.g., one, two, three, or more these oxidized heavy metals) can be measured in the sample after contacting the cathode.

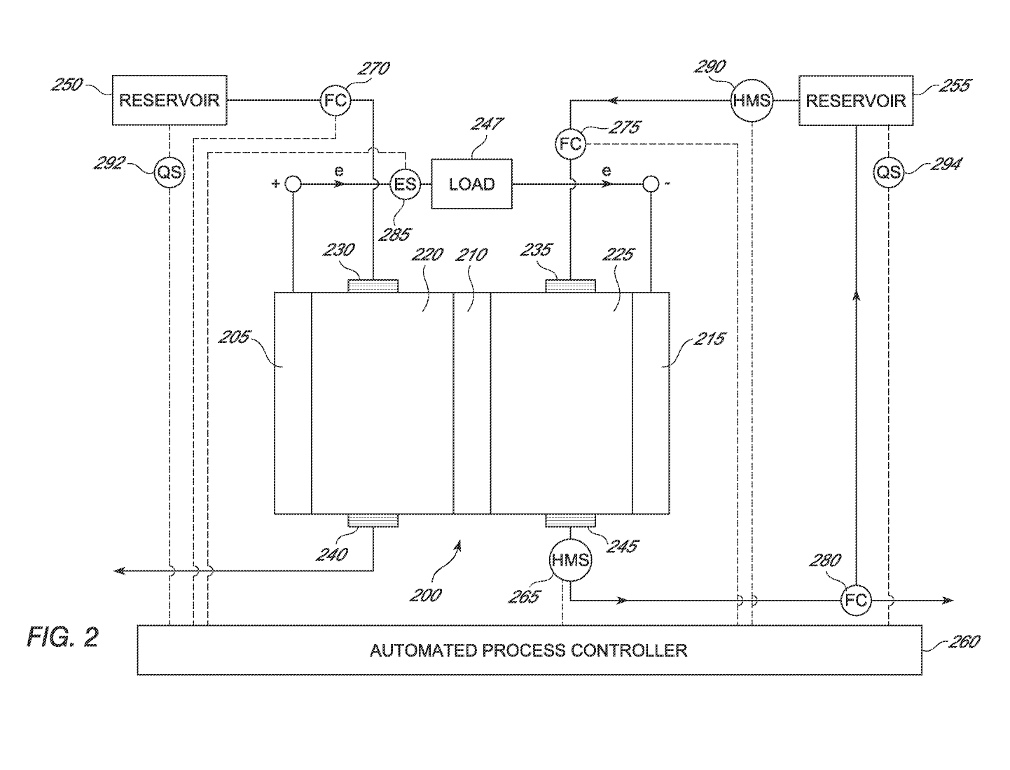

Some embodiments disclosed herein include a system for treating wastewater. The system may, in some embodiments, be configured to perform any of the methods disclosed in the present application. FIG. 2 is one example of a system for treating wastewater that is within the scope of the present application. Although various components are shown for the system depicted in FIG. 2, it will be appreciated that the systems within the scope of the present location may not include all of these components.

Fuel cell 200 can include generally the same components as those described above with respect to the fuel cell for the method of treating wastewater. Thus, fuel cell 200 includes anode 205, ion-exchange membrane 210, cathode 215, first chamber 220, second chamber 225, first inlet port 230, second inlet port 235, first outlet port 240, second outlet port 245, and load 247. These components may generally correspond to anode 110, ion-exchange membrane 130, cathode 120, first chamber 150, second chamber 160, first inlet port 170, second inlet port 175, first outlet port 180, second outlet port 185, and load 190 depicted in FIG. 1. Anode 205 can include a catalyst such as catalyst 140 depicted in FIG. 1 (not shown).

The system may include first reservoir 250 which is configured to contain the fuel and fluidly coupled to first input port 230. The fuel contained within first reservoir 250 can be any of the fuels described in the present application with regard to the method for treating wastewater having heavy metals or samples suspected of containing heavy metals. For example, first reservoir 250 may contain methanol and be fluidly coupled to first inlet port 230 via a conduit (e.g., one or more pipes). Thus, the fuel can be stored and delivered to anode 205 at an appropriate time.

The system may include second reservoir 255 which is configured to contain the wastewater and fluidly coupled to second input port 235. The wastewater contained within second reservoir 255 can be any of the wastewaters described above with regard to the methods. For example, second reservoir 255 may contain electroplating waste having oxidized heavy metals and be fluidly coupled to second inlet port 235 via a conduit (e.g. one or more pipes). Thus, the wastewater can be stored and delivered to cathode 215 at an appropriate time.

The system can include at least one automated process controller 260, which can be configured to execute instructions for treating the wastewater. In some embodiments, the automated process controller is configured to perform instructions for executing any of the methods for treating wastewater or treating a sample suspected of containing heavy metals disclosed in the present application. Automated process controller 260 can be in communication with the various components in the system to control treating the wastewater.

The system may include at least one heavy metal sensor 265 configured to measure an amount of one or more heavy metal ions in the wastewater. In some embodiments, heavy metal sensor 265 can be configured to measure an amount of one or more heavy metal ions in the treated wastewater that exits second outlet port 245. In some embodiments, heavy metal sensor 265 can be configured to measure an amount of at least one of Cu²⁺, Au³⁺, Au⁺, Cr⁶⁺, Ag⁺, or Hg²⁺ (e.g., one, two, three, or more of these oxidized heavy metals). Heavy metal sensor 265 can be, for example, a fluorometer, a spectrophotometer, and the like. Heavy metal sensor 265 may be in communication with automated process controller 260 and provide measurement results for the heavy metals. Automated process controller 260 may adjust certain operating conditions based on these measurements.

The system also includes first flow control device 270 fluidly coupled to first input port 230 and configured to adjust the flow of the fuel through first input port 230 (e.g., flow from first reservoir 250 to second input port 230). Automated process controller 260 may be in communication with first flow control device 270 and can adjust the flow of fuel to anode 205. For example, automated process controller 260 may receive measurement data from heavy metal sensor 265 indicating an amount of one or more heavy metals is above a pre-determined threshold. Automated process controller 260 may increase the flow of fuel from first reservoir 250 to first input port 230 using first flow control device 270, which may increase the rate that heavy metals are reduced in the fuel cell. As another example, the flow of fuel to the anode may be decreased when the amount of heavy metals is below a pre-determined threshold. First flow control device 270 may be, for example, a valve or a pump.

Second flow control device 275 may be fluidly coupled to second input port 235 and configured to adjust a flow of the wastewater through second input port 235 (e.g., flow from second reservoir 255 to second input port 235). Automated process controller 260 may be in communication with second flow control device 275 and can adjust the flow of wastewater to cathode 215. For example, automated process controller 260 may receive measurement data from heavy metal sensor 265 indicating an amount of one or more heavy metals is above a pre-determined threshold. Automated process controller 260 may decrease the flow of wastewater from second reservoir 255 to second input port 235 using second flow control device 275, which may increase exposure time of the wastewater to the cathode to further lower the amount of one or more oxidized heavy metals in the wastewater. Second flow control device 275 may be, for example, a valve or a pump.

Third flow control device 280 may be fluidly coupled between second outlet port 245 and second input port 235. Third flow control device 280 can be configured to adjust the flow of the treated wastewater that is recycled for further treatment. As shown in FIG. 2, third flow control device 280 can be configured to adjust a flow of treated wastewater from second output port 245 to second reservoir 255. The amount of treated wastewater sent to second reservoir 255 may be controlled by automated process controller 260 in communication with third flow control device 280. As an example, automated process controller 260 may receive measurement data from heavy metal sensor 265 indicating an amount of one or more heavy metals is above a pre-determined threshold. Automated process controller 260 may increase a flow of the treated wastewater to second reservoir 255 for further treatment. Also, when the amount of one or more oxidized heavy metals is below a threshold, the flow to second reservoir 255 can be decreased or discontinued. Although FIG. 2 shows third flow control device 280 fluidly coupled to second reservoir 255, third flow control device 280 can be fluidly coupled to second input port 235 in a configuration that bypasses second reservoir 255 (not shown). For example, a conduit may directly connect third flow control device 280 and second input port 235. Third flow control device 280 may be, for example, a valve or a pump.

The system may also include electrical sensor 285 electrically coupled to anode 205 and cathode 215. Electrical sensor 285 can be configured to measure at least one of a voltage or a current between anode 205 and cathode 215. Electrical sensor 285 may be in communication with automated process controller 260 and provide measurement results for the electric current between anode 205 and cathode 215. Automated process controller 260 may adjust certain operating conditions for the fuel cell based on these measurements. For example, automated process controller 260 may decrease a flow of wastewater to cathode 215 using second flow control device 275 when a current or voltage is below a pre-determined threshold. As another example, automated process controller 260 may increase a flow of fuel to anode 205 using first flow control device 270 when a current or voltage is below a pre-determined threshold. Electrical sensor 285 can be, for example, a voltmeter or an ammeter.

Second heavy metal sensor 290 can be configured to measure an amount of one or more oxidized heavy metals in the wastewater received at second input port 275. For example, second heavy metal sensor 290 can be fluidly coupled between second reservoir 255 and second input port 235. Second heavy metal sensor 290 can be, for example, a fluorometer, a spectrophotometer, and the like. Second heavy metal sensor 290 may be in communication with automated process controller 260 and provide measurement results for the heavy metals. Automated process controller 260 may adjust certain operating conditions based on these measurements. For example, automated process controller 260 may decrease a flow of wastewater to cathode 215 when an amount of one or more heavy metals is above a pre-determined threshold. Similarly, automated process controller 260 may increase a flow of wastewater to cathode 215 when an amount of one or more heavy metals is below a pre-determined threshold. As another example, automated process controller 260 may increase a flow of fuel to anode 205 when an amount of one or more heavy metals is above a pre-determined threshold. Similarly, automated process controller 260 may decrease a flow of fuel to anode 205 when an amount of one or more heavy metals in the wastewater is below a pre-determined threshold.

The system can also include first quantity sensor 292 configured to measure an amount of fuel in first reservoir 250. Automated process controller 260 may receive measurement results from first quantity sensor 292 and can be configured to adjust the process accordingly. For example, automated process controller 260 may stop processing wastewater when an amount of fuel in the reservoir is below a pre-determined threshold. First quantity sensor 292 can be, for example, a weighing device, a pressure sensor, or a volumetric sensor.

The system can also include second quantity sensor 294 configured to measure an amount of wastewater in second reservoir 255. Automated process controller 260 may receive measurement results from second quantity sensor 292 and can be configured to adjust the process accordingly. For example, automated process controller 260 may stop processing wastewater when an amount of fuel in the reservoir is at or below a pre-determined threshold. As another example, automated process controller 260 may stop or decrease a flow of treated wastewater to second reservoir 255 using third flow control device 280 when an amount of wastewater is above a pre-determined threshold (e.g., when second reservoir 255 is full or almost full). Second quantity sensor 294 can be, for example, a weighing device, a pressure sensor, or a volumetric sensor.

Automated process controller 260 may optionally be coupled to a display screen (not shown) for displaying various characteristics of the process. Non-limiting examples for the display screen include a CRT monitor, an LCD screen, a touch-screen, an LED display, and the like. Automated process controller 260 may display characteristics, such as an amount of one or more heavy metals in the wastewater before or after contacting the cathode, a flow rate of fuel to the anode, a flow rate of wastewater to the cathode, an amount of fuel in the first reservoir, an amount of wastewater in the second reservoir, a current or voltage between the anode and the cathode, and the like. Automated process controller 260 may also be optionally coupled to an input device, such as a keyboard, mouse, touchscreen, etc. The input device may allow a user to adjust various settings or variables for automated process controller 260 that modifies the how the system performs the method for processing organic material. Automated process controller 260 can include any type of a microprocessor (g), a microcontroller (X), a digital signal processor (DSP), or any combination thereof. Automated process controller 260 may also include system memory, such as any type of volatile memory (such as RAM), non-volatile memory (such as ROM, flash memory, etc.), or any combination thereof. The system memory may store instructions for performing the methods disclosed herein.

The systems and methods described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

With respect to the use of substantially any plural and/or singular terms herein, those having skill in the art can translate from the plural to the singular and/or from the singular to volume of wastewater can be received in the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

### EXAMPLES

Additional embodiments are disclosed in further detail, which are not intended in any way to limit the scope of the claims.

### Example 1

An electrochemical cell was constructed as shown in FIG. 1. A square commercial carbon cloth having an area of 0.5 cm² and coated with 10% Pt/C catalyst with Pt load of 1 mg/cm² was used as the anode. A square graphite sheet with an area of 1 cm² was used as cathode. The anode chamber contained 20 mL mixture of 20 mol/L methanol and 0.2 mol/L sodium hydroxide solution, whereas the cathode chamber was filled with 20 mL heavy metal wastewater containing 0.1 mol/L (5200 mg/L) of hexavalent chromium ions and 0.1M sodium sulphate. The cathode chamber and the anode chamber were separated by a bipolar membrane. The positive side of the membrane faces to the cathode and the negative side of the membrane faces to the anode. The electrochemical cell can supply electric power outwards. When connected to an external 50 ohm resistor, the voltage across the resistor was 0.557 V. Based on the area of the anode, the power density of the electricity output is calculated to be 124 W/m². The hexavalent chromium ions were reduced to low toxic trivalent chromium. The concentration of hexavalent chromium ions was monitored by spectrophotometry using diphenylcarbazide (Chinese National Standard GB7467-87) and was about 1 ppm.

These results demonstrate successfully reducing toxic hexavalent chromium ions to trivalent chromium having significantly lower toxicity.

### Example 2

The process in Example 1 was repeated except that 2 mg/cm² of 20% Pt/C catalyst was coated on the anode. The voltage across the resistor was 0.599 V, while the power density was 144 W/m². The final concentration of hexavalent chromium ions was about 1 ppm.

These results demonstrate that a greater amount of catalyst on the anode can improve power output while still successfully reducing toxic hexavalent chromium ions to trivalent chromium having significantly lower toxicity.

### Example 3

The process in Example 1 was repeated except that 0.1 mol/L (6400 mg/L) copper sulfate was supplied to the cathode rather than hexavalent chromium. When a 500 ohm resistor was connected to the anode the cathode, the voltage across the resistor was 0.7 V, while the power density was 20 W/m². The copper ions were reduced to elemental copper that deposited on the cathode. The concentration of copper ions was monitored using an inductively coupled plasma-atomic emission spectrometer (ICP-AES) and was about 1 ppm. These results demonstrate toxic copper ions can be successfully removed.

### Example 4

The process in Example 3 was repeated except that 2 mg/cm² of 20% Pt/C catalyst was coated on the anode. When a 75 ohm resistor was connected to the anode the cathode, the voltage across the resistor was 0.321 V, while the power density is 27 W/m². The copper ions were completely reduced to elemental copper that deposited on the cathode. The concentration of copper ions was about 1 ppm.

These results demonstrate that a greater amount of catalyst on the anode can improve power output while still successfully removing toxic copper ions from the wastewater.

1. A method for treating wastewater containing one or more heavy metals, the method comprising:
providing a fuel cell comprising:
an anode comprising a catalyst;
a cathode electrically coupled to the anode; and
an ion-exchange membrane disposed between the anode and the cathode;
contacting a fuel with the anode to oxidize the fuel;
contacting the wastewater with the cathode to reduce at least a portion of the heavy metals in the wastewater, wherein an electrical current flows between the anode and the cathode.

2. The method of claim 1, wherein the catalyst comprises at least one of Pt, Ru, Rh, Os, Sn, or an alloy thereof.

3. (canceled)

4. The method of claim 1, wherein the fuel comprises at least one of a hydrocarbon, an alcohol, or hydrogen.

5. The method of claim 1, wherein the fuel comprises at least one of ethanol, methanol, isopropanol, or glycerol.

6. The method of claim 1, wherein the heavy metals comprise at least one oxidized form of Cr, Cu, Cd, Hg, Au, or Ag.

7. (canceled)

8. The method of claim 1, wherein the wastewater comprises at least about 1 ppm of the heavy metals.

9. The method of claim 1, wherein at least about 50% by weight of at least one of the heavy metals are reduced in the wastewater.

10. (canceled)

11. (canceled)

12. The method of claim 1, wherein a power output from the fuel cell relative to an area of the anode is at least about 10 W/m².

13. The method of claim 1, wherein the wastewater comprises at least one of electroplating waste, mining waste, silver plating waste, industrial chemical waste, metallurgy waste, textile manufacturing waste, leather processing waste, or pesticide manufacturing waste.

14. The method of claim 1, wherein the fuel cell has a temperature of at least about −5° C. and the fuel has a temperature of no more than about 50° C.

15. (canceled)

16. (canceled)

17. The method of claim 1, wherein the ion exchange membrane is a cation exchange membrane, anion exchange membrane, or a bipolar membrane.

18. (canceled)

19. The method of claim 1, further comprising harvesting at least a portion of the heavy metals reduced by the cathode.

20. (canceled)

21. (canceled)

22. (canceled)

23. A system for treating wastewater, the system comprising:
an anode comprising a catalyst;
a cathode electrically coupled to the anode;
an ion-exchange membrane disposed between the anode and the cathode;
a first input port configured to provide a fuel to the anode;
a second input port configured to provide a wastewater to the cathode; and
a heavy metal sensor configured to measure an amount of one or more heavy metal ions in the wastewater.

24. The system of claim 23, further comprising a first output port configured to receive oxidized fuel from the anode.

25. The system of claim 23, further comprising a second output port configured to receive the wastewater after the wastewater contacts the cathode.

26. The system of claim 25, wherein the heavy metal sensor is configured to measure an amount of one or more heavy metal ions in the wastewater received by the second output port.

27. The system of claim 23, further comprising a second heavy metal sensor configured to measure an amount of one or more heavy metal ions in the wastewater provided by the second input port.

28. The system of claim 23, further comprising a first reservoir fluidly coupled to the first input port, the first reservoir containing the fuel.

29. The system of claim 23, wherein the fuel comprises at least one of a hydrocarbon, an alcohol, or hydrogen.

30. The system of claim 23, further comprising a second reservoir fluidly coupled to the second input port, the second reservoir containing the wastewater.

31. The system of claim 23, wherein the wastewater comprises at least one of electroplating waste, mining waste, silver plating waste, industrial chemical waste, metallurgy waste, textile manufacturing waste, leather processing waste, or pesticide manufacturing waste.

32. The system of claim 23, further comprising a first flow control device fluidly coupled to the first input port, the first flow control device configured to adjust a flow of the fuel through the first input port.

33. The system of claim 23, further comprising a second flow control device fluidly coupled to the second input port, the second flow control device configured to adjust a flow of the wastewater through the second input port.

34. The system of claim 23, wherein the second output port is fluidly coupled to the second input port via a third flow control device, the third flow control configured to adjust a flow of the wastewater from the second output port to the second input port.

35. (canceled)

36. The system of claim 23, further comprising an electrical sensor electrically coupled to the anode and the cathode, the electrical sensor configured to measure at least one of a voltage or a current between the anode and the cathode.

37. The system of claim 36, further comprising an automated process controller configured to execute instructions for treating the wastewater, the automated process controller is in communication with at least one of the first flow control device, the second flow control device, the third flow control device, the first heavy metal sensor, the second heavy metal sensor, or the electrical sensor.
